(19) United States
(12) Patent Application Publication
(10) Pub. No.: US 2023/0174181 A1
(43) Pub. Date: Jun. 8, 2023

(54) ALL-TERRAIN VEHICLE

(71) Applicant: Polaris Industries Inc., Medina, MN (US)

(72) Inventors: Cody D. Johnston, Roseau, MN (US); Brent J. Hanson, Warroad, MN (US); Brian N. Flick, Maple Grove, MN (US); Cameron D. Fisher, Plymouth, MN (US); Nathan D. Dahl, Salol, MN (US); Peter D. Watson, Minnetrista, MN (US)

(73) Assignee: Polaris Industries Inc., Medina, MN (US)

(21) Appl. No.: 17/972,184

(22) Filed: Oct. 24, 2022

Related U.S. Application Data
(60) Provisional application No. 63/285,868, filed on Dec. 3, 2021.

(51) Int. Cl. B62J 1/08; B62J 9/10

(52) U.S. Cl. CPC B62J 1/08; B62J 9/10

(57) ABSTRACT

A vehicle includes a vehicle frame, a saddle-type seat mounted to the frame and having a forward portion and a rearward portion, a cargo area defining a storage compartment positioned at least partially rearward of the saddle-type seat, and a rider support assembly positioned rearward of the forward portion of the saddle-type seat and vertically above at least a portion of the saddle-type seat and the storage compartment.

### CROSS-REFERENCE TO RELATED APPLICATION

The present application claims priority to U.S. Provisional Patent Application No. 63/285,868, filed Dec. 3, 2021, the entire disclosure of which is incorporated herein by reference.

### FIELD OF THE DISCLOSURE

The present disclosure relates to all-terrain vehicle seating arrangements and, more particularly, to passenger seat assemblies for providing comfortable and convenient configurations.

### BACKGROUND OF THE DISCLOSURE

Generally, all-terrain vehicles (“ATVs”) and utility vehicles (“UVs”) are used to carry one or two passengers and a small amount of cargo over a variety of terrains. Due to increasing recreational interest in ATVs, ATVs for multiple riders have become more popular in the marketplace. Most ATVs include an engine including between one and three cylinders. Most ATVs include a saddle-type seat being secured to a frame structure.

Conventional saddle-type seats on recreational and utility vehicles generally hold a number of people, and most commonly, the seats function in supporting one or two persons. In one example, a two-person seating system is designed with an elongated bench portion of the saddle type seat so as to support one person in front of the other. In another example, discrete seat bottoms are provided for supporting one person in front of the other, with the passenger elevated in relation to the driver. Multi-person seats may be uncomfortable to use due to lack of support and ergonomic designs, especially for passengers that lack other supports such as handlebars. This problem becomes even more pronounced during long rides such as during touring.

Furthermore, when multi-person seats are implemented, especially during touring, storage may be limited on the ATV as the passenger is positioned generally where cargo may be stored during use of the ATV.

As such, there is a need for ATVs providing comfortable ride and convenient use for ATV riders.

### SUMMARY OF THE DISCLOSURE

In one aspect, a vehicle includes a vehicle frame, a saddle-type seat mounted to the frame and having a forward portion and a rearward portion, a cargo area defining a storage compartment positioned at least partially rearward of the saddle-type seat, and a rider support assembly positioned rearward of the forward portion of the saddle-type seat and vertically above at least a portion of the saddle-type seat and the storage compartment.

In another aspect, the rider support assembly includes a seat frame assembly and a seating assembly supported by the seat frame assembly.

In another aspect, the seating assembly includes a support member coupled to the seat frame assembly and an interface member coupled to the support member.

In another aspect, the interface member includes a seat back and a seat bottom integrally formed with each other.

In another aspect, the seat bottom includes a top surface operable to support a rider and a bottom surface operable to interface with the saddle-type seat.

In another aspect, the bottom surface includes a profile corresponding to a profile of the saddle-type seat.

In another aspect, the interface member is formed of a compressible material.

In another aspect, the seat bottom is pivotable relative to the seat back.

In another aspect, at least a portion of the seat frame assembly is exposed and not concealed by the seating assembly.

In another aspect, the seating assembly defines a channel within which the seat frame assembly is positioned, and wherein the seating assembly defines a recess from an outer surface of the seating assembly and at least partially beyond the channel such that a portion of the seat frame assembly is circumferentially accessible at the recess in the seating assembly.

In another aspect, the recess includes at least four recesses providing access to at least four portions of the seat frame assembly, the at least four portions including two vertical portions and two horizontal portions.

In another aspect, the recess extends such that the seating assembly is spaced from the seat frame assembly at the recess.

In another aspect, the seat frame assembly includes a release mechanism operable to be actuated to release the rider support assembly from the vehicle.

In another aspect, the vehicle further includes a corresponding coupling member operably engaged to the release mechanism of the seat frame assembly to couple the seat frame assembly to the vehicle.

In another aspect, the seat frame assembly includes an aperture defined therethrough, and wherein the release mechanism is positioned proximate the aperture.

In another aspect, the corresponding coupling member is electrified such that when the release mechanism and the corresponding coupling member are in contact, a circuit of the seat frame assembly is completed.

In another aspect, the seat frame assembly includes an anchoring portion retained by a retainer of the vehicle for anchoring the seat assembly on the vehicle.

In another aspect, the retainer is positioned on the cargo area.

In another aspect, the cargo area includes location members extending therefrom, the cargo areas operable to align the anchoring portion of the seat frame assembly with the retainer during installation of the rider support assembly.

In another aspect, the rider support assembly includes arm supports extending therefrom.

In another aspect, the arm supports include a grip portion operable to be removed and replaced.

In another aspect, the grip portion may include heated handgrips.

In another aspect, the arm supports extend from the rider support assembly at a position vertically above a seat bottom.

In one aspect, a rider support assembly includes a seat frame assembly coupling portion operable to be coupled to a vehicle and a vertically extending member extending substantially vertically from the coupling portion and a seating assembly including: a structural interface member coupled to the vertically extending member of the seat frame assembly; and an rider interface member coupled to the support member, the rider interface member including a seat back and a seat bottom, the seat back being supported by the structural interface member.

In another aspect, the seating assembly includes a support member coupled to the seat frame assembly and an interface member coupled to the support member.

In another aspect, the interface member includes a seat back and a seat bottom integrally formed with each other.

### BRIEF DESCRIPTION OF THE DRAWINGS

FIG. 1 is a front, left perspective view of an all-terrain vehicle with a rider support assembly of the present application;

FIG. 2 is a rear, left perspective view of the all-terrain vehicle of FIG. 1;

FIG. 3 is a left side view of the all-terrain vehicle of FIG. 1;

FIG. 4 is a top view of the all-terrain vehicle of FIG. 1;

FIG. 5 is a rear view of the all-terrain vehicle of FIG. 1;

FIG. 6 is a front, left perspective view of the rider support assembly positioned on a saddle-type seat of FIG. 1;

FIG. 7 is an exploded view of a release mechanism of the rider support assembly of FIG. 6;

FIG. 8 is a cross-section view of the release mechanism of the rider support assembly of FIG. 6, taken along line 8-8 of FIG. 6;

FIG. 9 is a perspective view of a frame of the rider support assembly engaging with the all-terrain vehicle of FIG. 1;

FIG. 10 is a rear, left perspective view of the frame of the rider support assembly of FIG. 1;

FIG. 11 is an exploded view of the frame of the rider support assembly of FIG. 10;

FIG. 12 is a rear, left perspective view of the frame of the rider support assembly of FIG. 10;

FIG. 13 is an exploded view of the frame of FIG. 12;

FIG. 14 is a perspective view of a second embodiment of a rider support assembly of the vehicle of FIG. 1;

FIG. 15 is a rear, right perspective view of the rider support assembly of FIG. 14;

FIG. 16 is a front, left perspective view of a third embodiment of a rider support assembly of the vehicle of FIG. 1;

FIG. 17 is a front, left perspective view of a of bracket for an underside of a rider support assembly;

FIG. 18 is a front, left perspective view of a second embodiment of an underside of a bracket for a rider support assembly;

FIG. 19 is a front, left perspective view of a third embodiment of an underside of a bracket for a rider support assembly;

FIG. 20 is a front, left perspective view of a fourth embodiment of an underside of a bracket for a rider support assembly;

FIG. 21 is a front, left perspective view of a fifth embodiment of an underside of a bracket for a rider support assembly;

FIG. 22 is a perspective view of an embodiment of a rider support assembly positioned above a storage compartment; and

FIG. 23 is a side view of a rider support assembly of any embodiment disclosed herein and pivoted away from a storage compartment.

### DETAILED DESCRIPTION

For the purposes of promoting an understanding of the principals of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. For example, while the following description refers primarily to a snowmobile, it should be understood that the principles of the invention apply equally to other snow vehicles. While the present invention primarily involves an all-terrain vehicle (“ATV”), it should be understood, however, that the invention may have application to other types of vehicles, such as motorcycles, snowmobiles, utility vehicles, scooters, and mopeds. It will be understood that no limitation of the scope of the invention is thereby intended. The invention includes any alterations and further modifications in the illustrative devices and described methods and further applications of the principles of the invention which would normally occur to one skilled in the art to which the invention relates.

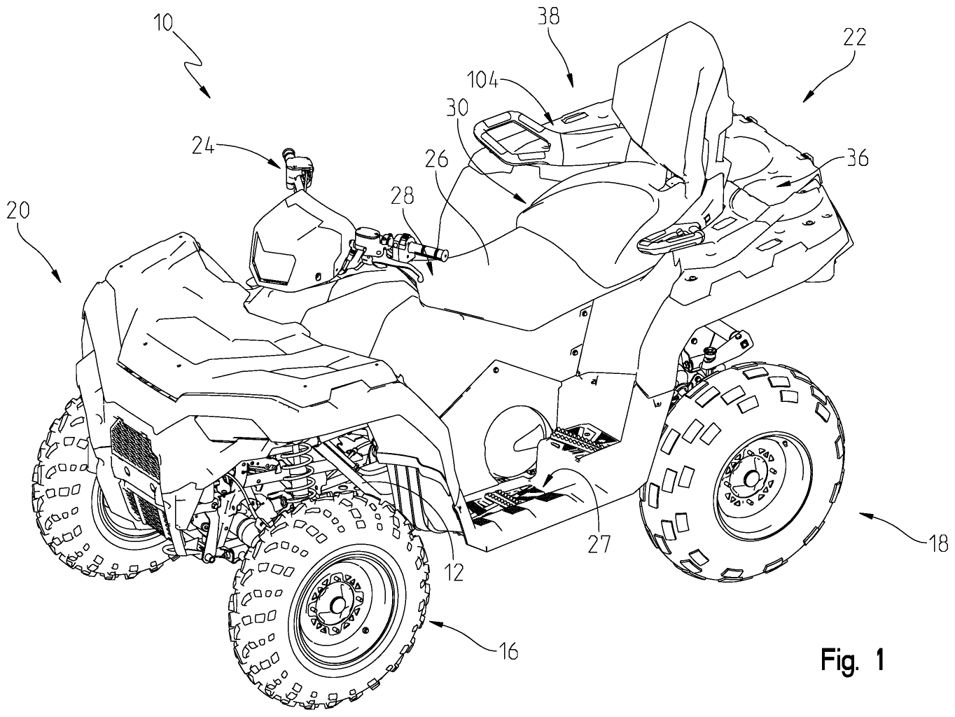

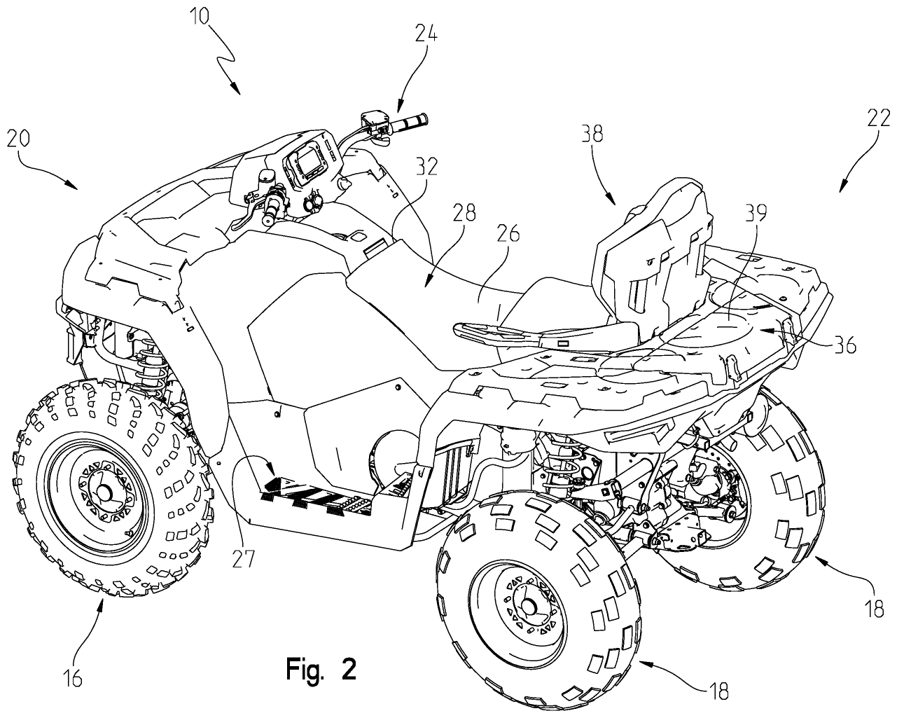

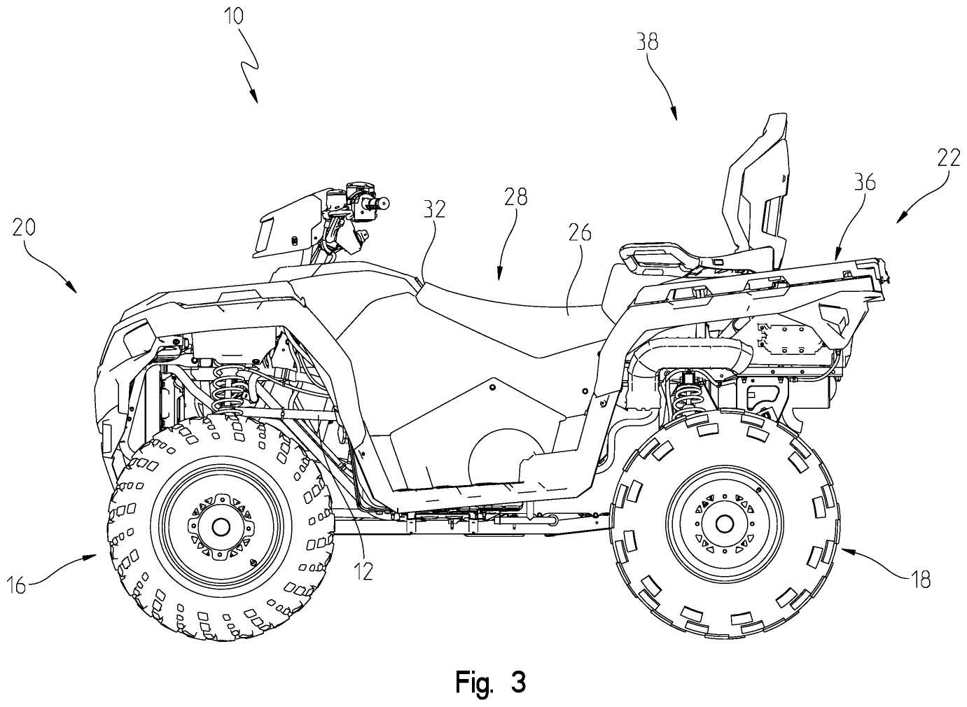

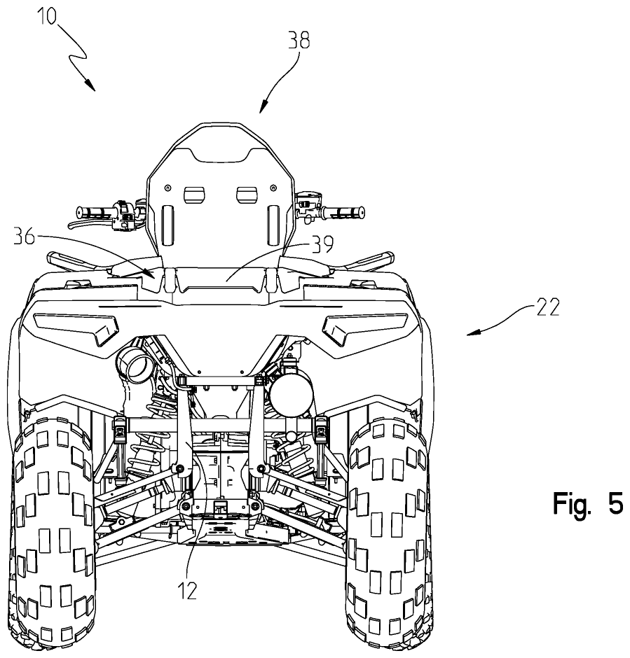

Referring initially to FIGS. 1-5, one illustrative embodiment of an all-terrain vehicle (ATV) 10 is shown. The ATV 10 includes a frame 12, where the frame 12 is supported by ground engaging members (e.g., front and rear tires 16, 18). The ATV 10 also includes a front end 20 and a rear end 22. The ATV 10 includes a handlebar assembly 24, a saddle-type seat 26, and footwells 27 (e.g., generally positioned longitudinally between the front end 20 and rear end 22). Footwells 27 are located on both lateral sides of ATV 10, and flank the saddle-type seat 26, providing an area for the driver and passenger's feet. The saddle-type seat 26 includes a forward portion 28 and a rearward portion 30. In some embodiments, the saddle-type seat 26 supports only the driver.

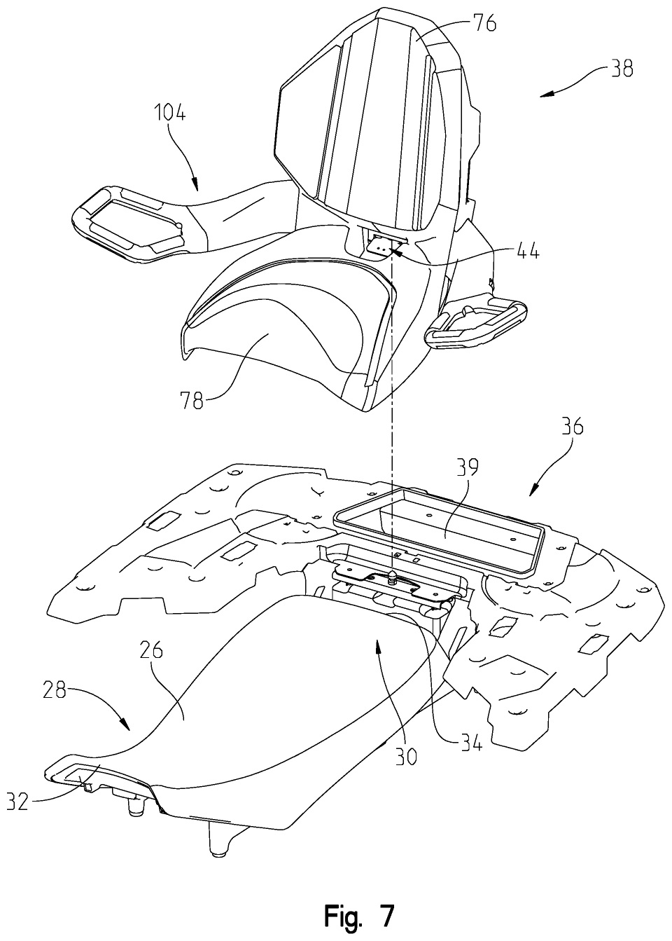

In some embodiments, the ATV 10 includes a cargo area 36 that is positioned at the rear of the ATV 10. The cargo area 36 defines a storage compartment 37 and, in some embodiments, includes an access panel 39 for accessing the storage compartment 37. The cargo area 36 is positioned at least partially rearward of the saddle-type seat 26. For example, the cargo area 36 may be positioned such that a portion is longitudinally rearward of the rear edge 34 of the saddle-type seat 26 and a portion is longitudinally forward of the rear edge 34 and, therefore, may be overlapping with at least a portion of the saddle-type seat 26 (e.g., the rearward portion 30). At least portion of the cargo area 36 may be positioned vertically below a portion of the saddle-type seat 26 (e.g., the seat back). Furthermore, at least a portion of the cargo area 36 may be positioned directly beneath the saddle-type seat 26 such that it is both vertically below the saddle-type seat 26 and longitudinally overlapping with the saddle-type seat 26 (see FIGS. 7-9).

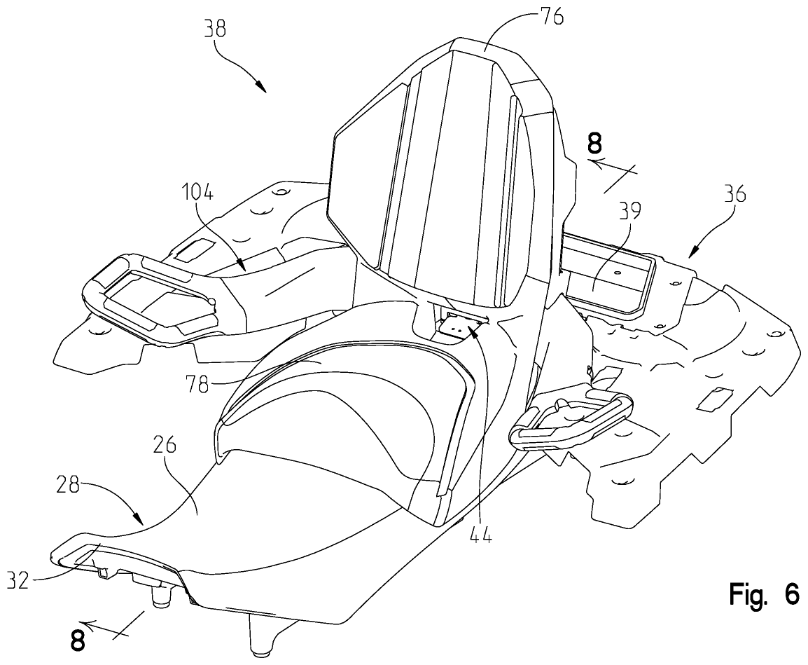

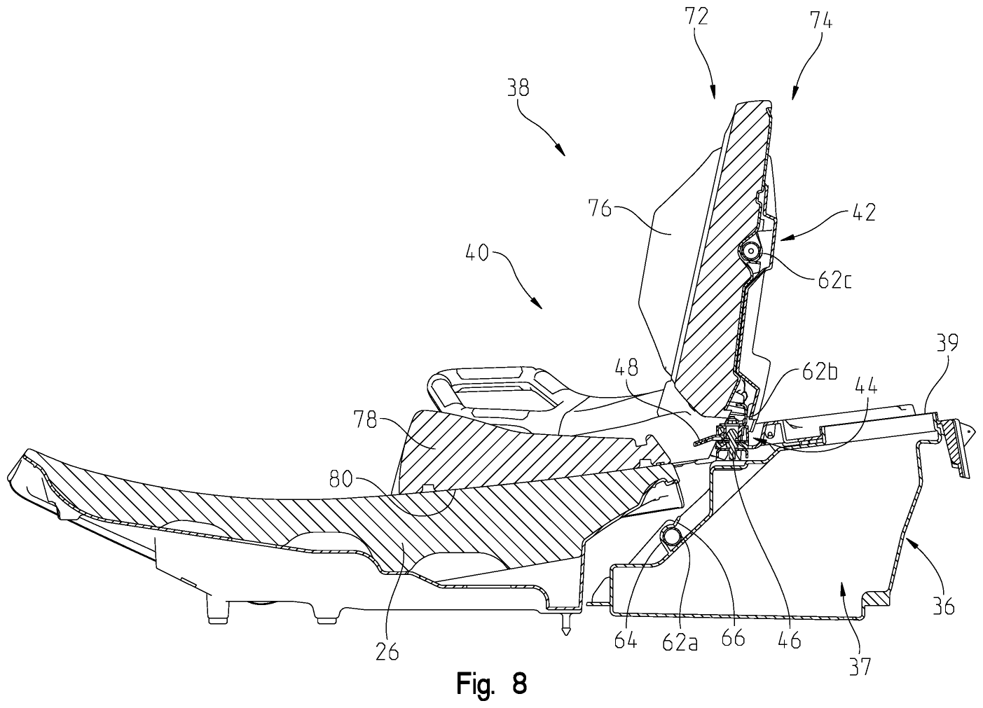

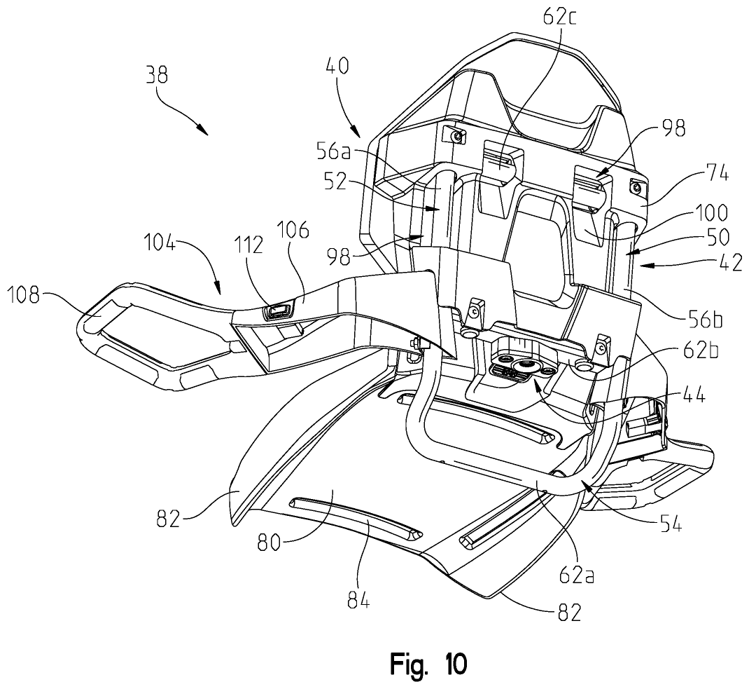

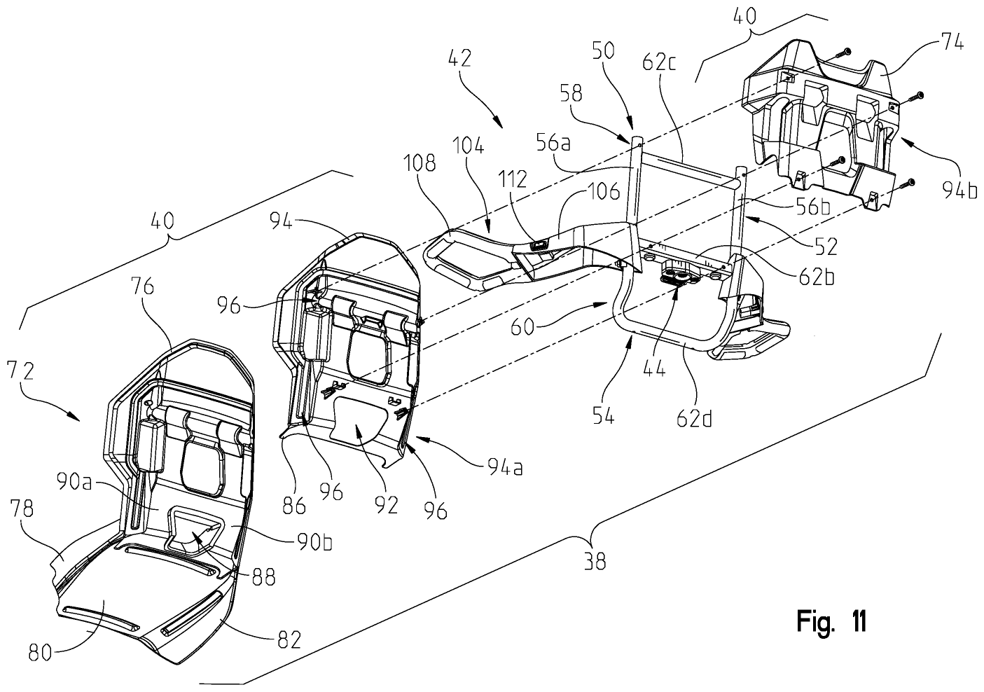

Referring to FIGS. 1-6, positioned rearward of at least a portion of the saddle-type seat 26 is a rider support assembly 38, which includes a seating assembly 40 (e.g., comprised of at least a seat bottom cushion and a seat back cushion) and a seat frame assembly 42 (see FIGS. 10 and 11). In various embodiments, the seating surfaces (e.g., seat cushions) of seating assembly 40 are integral with the seat frame assembly 42. As described herein, the rider support assembly 38 is selectively removable from the ATV 10 by way of a release mechanism 44. In some embodiments, the rider support assembly 38 is positioned rearward of the forward portion 28 of the saddle-type seat 26 and vertically above at least a portion of the saddle-type seat 26 and the cargo area 36. The rider support assembly 38, when engaged with the ATV 10, may be positioned such that at least a portion of the rider support assembly 38 is supported directly by the saddle-type seat 26. For example, a portion of the rider support assembly 38 may be formed to correspond to a profile of a portion of the saddle-type seat 26 such that the portion of the rider support assembly 38 rests directly on top of the saddle-type seat 26 (e.g., the rearward portion 30) (see FIGS. 6 and 8). In those embodiments in which the saddle-type seat 26 is implemented for a passenger, the rider support assembly 38 may be positioned generally on top of where the passenger is intended to sit and the passenger instead is positioned on the rider support assembly 38 when riding the ATV 10. The rider support assembly 38 may also be positioned vertically above at least a portion of the cargo area 36 (see FIG. 8).

Referring to FIGS. 7 and 8, the seat frame assembly 42 generally provides structural support of the rider support assembly 38 and is operably coupled (either directly or indirectly) to the ATV 10 (e.g., via the release mechanism 44). For example, FIG. 6 illustrates an exemplary embodiment in which the rider support assembly 38 is operable to removably couple to the ATV 10 via the release mechanism 44, which interfaces with a coupling member 46 positioned on the ATV 10. A variety of release mechanisms and coupling members 46 may be implemented and are not limited specifically to those illustrated herein (e.g., various quick release or non-quick release mechanisms). For example, in one embodiment, the coupling member 46 may include a pin which is coupled to a structurally supported portion of the ATV 10 (e.g., the frame 12 or cargo area 36) and the release mechanism 44 receives and couples to the pin of the coupling member 46 to releasably secure the rider support assembly 38 to the ATV 10.

The release mechanism 44 is actuated to release the rider support assembly 38 from the ATV 10. For example, the release mechanism 44 includes a handle or lever 48 which can be actuated to release the coupling between the release mechanism 44 and the coupling member 46. The handle 48 may be positioned away from the cargo area 23 relative to the coupling member 46 such that the handle 48 does not interfere with the cargo area 36 or access into the storage compartment 37. Access to the handle 48 and the release mechanism 44 is described in further detail hereafter. Furthermore, it is understood that the release mechanism 44 is not necessarily the only position at which the rider support assembly 38 interfaces and/or is anchored or coupled with the ATV 10. Other such interfaces and couplings are described herein. However, it is understood that the release mechanism 44 can be the singular coupling location at which the user needs to unlock or disengage the rider support assembly 38 from the ATV 10 via an actuatable release. Stated otherwise, the rider support assembly 38 may interface with the ATV 10 at various positions, however, the release mechanism 44 secures the rider support assembly 38 to the ATV 10 and may be manually disengaged in order to release the rider support assembly 38 from the ATV 10.

In some embodiments the coupling member 46 is electrified such that when the release mechanism 44 and the coupling member 46 are in contact, an electrical circuit of the rider support assembly 38 is completed. This allows power to be provided to the rider support assembly 38 for various accessories or functionalities while retaining a single coupling for the rider support assembly 38. Because the rider support assembly 38 includes a single coupling point (e.g., via the release mechanism 44), the rider support assembly 38 is easily installed and removed from the ATV 10. In some embodiments, the rider support assembly 38 may include a separate wiring harness (not shown) for electrification of the rider support assembly 38. Electrification of the rider support assembly 38 allows the rider support assembly 38 to pull power from the ATV 10 and reduces the need for onboard, personal power sources on the rider support assembly 38. Additional details of the release mechanism 44 and the coupling member 46 may be disclosed in U.S. Pat. No. 8,905,435, filed on May 4, 2012, issued on Dec. 9, 2014, and entitled “ATV HAVING ARRANGEMENT FOR A PASSENGER” (Attorney Docket No.: PLR-02-1993.02P-US), the complete disclosure of which is expressly incorporated by reference herein.

Referring to FIGS. 10 and 11, the rider support assembly 38 includes the seating assembly 40 and the seat frame assembly 42 which may form a single unit that is operable to be installed and removed from the ATV 10. The rider support assembly 38 is thus conveniently removable, in its entirety, from the ATV 10 such that multiple portions do not have to be independently removed from the ATV 10 or independently installed. In this way, if it is desired to remove the rider support assembly 38 from the ATV 10, the driver merely needs to disengage the release mechanism 44 for the entirety of the rider support assembly 38 (e.g., the seating assembly 40 and the seat frame assembly 42) to be removable from ATV 10.

The seat frame assembly 42 provides structural support for the seating assembly 40 which supports the user. The seat frame assembly 42 also provides the interface for structurally securing the rider support assembly 38 to the ATV 10. For example, the seat frame assembly 42 includes a frame 50 that interfaces with the ATV 10. The frame 50 is the main support for the seating assembly 40 on the ATV 10 and supports the load of the passenger on the ATV 10. The frame 50 may also include the release mechanism 44 previously discussed, the release mechanism 44 being coupled either directly or indirectly to the frame 50. The frame 50 includes a rider support portion 52 and a vehicle interface portion 54. The rider support portion 52 generally provides the structural support for supporting the rider via the seating assembly 40 (e.g., the rider support portion 52 of the frame 50 supports at least a portion of the seating assembly 40). The vehicle interface portion 54 interfaces with the ATV 10 and is releasable retained on the ATV 10 to provide a secure coupling of the rider support assembly 38 to the ATV 10.

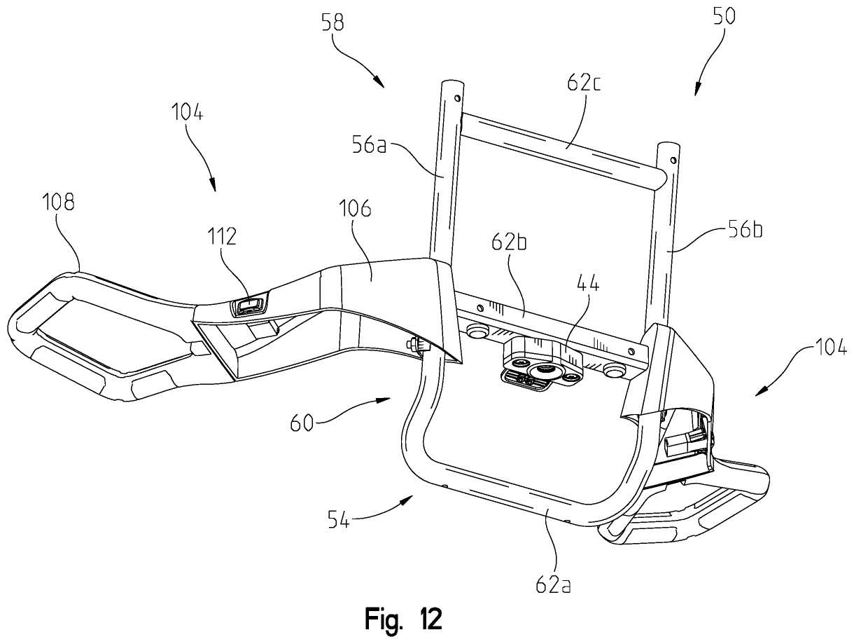

Referring to FIG. 12 and the frame 50 of seat frame assembly 42, the frame 50 may comprise vertically extending members 56a and 56b. The vertically extending members 56a, 56b may provide the rider support portion 52 of the frame 50 at an upper portion 58 of the vertically extending members 56a, 56b and at least a portion of the vehicle interface portion 54 at the lower portion 60 of the vertically extending members 56a, 56b. Any number of vertically extending members 56 may be implemented, including one, two, three, four, or more. As illustrated in FIG. 11, the vertically extending members 56a, 56b may be disposed generally parallel to each other. The frame 50 may also include at least one horizontally extending member 62. For example, a first horizontally extending member 62a may extend between the two vertically extending members 56a, 56b. The first horizontally extending member 62a may extend between the vertically extending members 56a, 56b at the lower portion 60 of the vertically extending members 56a, 56b and, in one embodiment, may be integrally formed with the vertically extending members 56a, 56b. The first horizontally extending member 62a may also define or comprise the vehicle interface portion 54. The frame 50 may include any number of horizontally extending members 62, including one, two, three, four, or more horizontally extending members 62. In some embodiments, the seat frame assembly 42 includes a second horizontally extending member 62b and a third horizontally extending member 62c. The second and third horizontally extending members 62b, 62c act as cross members to support and/or structurally reinforce the vertically extending members 56a, 56b. The second horizontally extending member 62b may support the release mechanism 44. The third horizontally extending member 62c extends between the vertically extending members 56a, 56b at the rider support portion 52. The frame 50 may be formed of a single, integrated member (e.g., tube frame) or may be formed of various, independent members. As illustrated, the frame 50 may be formed in a U-shape.

Referring to the vehicle interface portion 54 of the frame 50, the lower portion 60 of the vertically extending members 56a, 56b may include a curve or a bend. The curve or bend in the vertically extending members 56a, 56b permits the first horizontally extending member 62a to be longitudinally offset from the second horizontally extending member 62b and the release mechanism 44 (see FIG. 8). When the first horizontally extending member 62a and the release mechanism 44 are coupled to the ATV 10, the release mechanism 44 is positioned vertically above and longitudinally rearward of the first horizontally extending member 62a, which provides reinforcement against torsional forces applied to the rider support assembly 38. The bend may also provide the ability to engage the rider support assembly 38 with the ATV 10 by fitting into concealed spaces with indirect or blind access (e.g., between the saddle-type seat 26 and the cargo area 36). The bend of the vertically extending members 56a, 56b also provides an angle of the seat back that may increase the passenger's comfort.

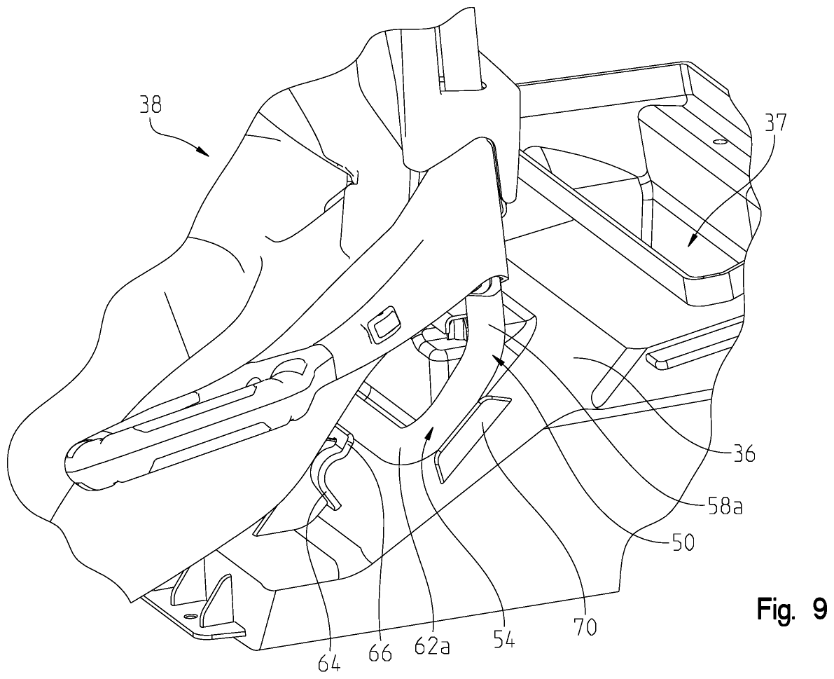

Referring now to FIGS. 8 and 9, the lower portion of the U-shape of the frame 50 (e.g., the first horizontally extending member 62a) acts as a portion of a lower latching mechanism. The first horizontally extending member 62a is used to secure the lower portion of the vehicle interface portion 54 of the frame 50 to the ATV 10. The horizontally extending member 62a is lowered into a retainer 64 (e.g., a latch) positioned on the ATV 10 (e.g., on the cargo area 36), where horizontally extending member 62a is received and secured in place. As previously discussed, the release mechanism 44 positioned on the second horizontally extending member 62b secures a second portion of the frame 50 to the ATV 10. The release mechanism 44 secures the rider support assembly 38 onto the ATV 10 until the release mechanism 44 is actuated to disengage. In order to remove the rider support assembly 38 from the ATV 10, the operator actuates the release mechanism 44 and translates (e.g., lifts) the frame 50 away from the ATV 10, thus disengaging the horizontally extending member 62a from the retainer 64.

The retainer 64 illustrated herein is not intended to be limiting and therefore any appropriate retainer 64 may be implemented. The retainer 64, as illustrated, extends from the cargo area 36 and defines a space within which the horizontally extending member 62a may be positioned when securing the rider support assembly 38 to the ATV 10. The retainer 64 may be formed of a resilient material that allows the retainer 64 to flex and bend during installation and removal of the rider support assembly 38 onto and from the ATV 10. For example, when the horizontally extending member 62a includes a circular profile, the retainer 64 may define a semi-circular profile that is operable to grip and retain the horizontally extending member 62a. The retainer 64 may also include a flange 66 which provides a ramp that facilitates insertion of the horizontally extending member 62a into the retainer 64 and to which the horizontally extending member 62a applies a force to flex the retainer 64 when coupling or removing the rider support assembly 38 to or from the ATV 10. By having the retainer 64 sized such that the retainer 64 must be flexed during coupling or removal, the retainer 64 also provides enhanced coupling of the frame 50 to the ATV 10 in addition to the release mechanism 44. Furthermore, the retainer 64 also provides haptic feedback to the operator when installing the frame 50 onto the ATV 10 that the frame 50 is properly positioned and the release mechanism 44 can be secured to the coupling member 46.

Referring to FIG. 9 more specifically, the cargo area 36 may further include locating members 70 which are positioned to engage the vertically extending members 56a, 56b of the frame 50 during installation of the frame 50. For example, the locating members 70 are positioned at least equal to a distance between the outer profile of the vertically extending members 56a, 56b. The locating members 70 deflect the frame 50 into the appropriate position laterally for the frame 50 to be properly engaged with the ATV 10 (e.g., via the release mechanism 44, the coupling member 46, and the retainer 64). Also, because the insertion of the horizontally extending member 62a into the retainer 64 may be a blind insertion, the locating members 70 provide mechanical resistance or obstacles for inserting the horizontally extending member 62A at an incorrect position and help guide and retain the horizontally extending member 62A into and at an appropriate lateral position for insertion of the horizontally extending member 62A into the retainer 64. The locating members 70 further provide lateral support to the frame 50 when installed on the ATV 10, thus limiting lateral movement of the rider support assembly 38 on the ATV 10.

Referring now to FIG. 11, the rider support assembly 38 includes the seating assembly 40 that is coupled to the seat frame assembly 42. The seating assembly 40 includes a rider interface member 72 and a structural interface member 74. The rider interface member 72 may be defined as the seat cushions (e.g., a seat bottom cushion and/or a seat back cushion) and interfaces directly with the passenger when in use. The structural interface member 74 is operably coupled to the rider interface member 72 and the frame 50 of the seat frame assembly 42. The rider interface member 72 may be formed of a compressible or compliant material (e.g., foams) to provide the passenger with a more comfortable riding experience, whereas the structural interface member 74 may be formed of a more rigid material (e.g., hard plastics such as polyethylene, polypropylene, high-density polyethylene, and so forth) to provide support to the profile of the rider interface member 72 while maintaining a secure coupling to the seat frame assembly 42.

The rider interface member 72 includes a seat back 76 and a seat bottom 78. The seat back 76 and the seat bottom 78 may be formed as a single integral unit, however, in other embodiments, the rider interface member 72 may define separate seat bottom and seat back cushions. Because the seat back 76 and the seat bottom 78 are integrally formed in the illustrative embodiment, they do not need to be coupled together. In some embodiments, the seat back 76 and seat bottom 78 are permanently coupled together (e.g., via adhesive, plastic welding, etc.) during assembly and thus form an integral unit for use. By having an integral unit forming the seat back 76 and seat bottom 78, the rider support assembly 38 reduces the number of parts that are installed onto the ATV 10 or that need to be removed from the ATV 10 for use and removal of the rider support assembly 38. Although the seat bottom 78 and the seat back 76 may be integral members, a living hinge may be formed between the two such that the seat bottom 78 may be pivoted relative to the seat back 76. This allows the seat bottom 78 to be adjusted on the saddle-type seat 26.

The seat back 76 of the rider interface member 72 is coupled to the structural interface member 74, and at least a portion of the seat bottom 78 rests on at least a portion of the saddle-type seat 26 (see FIG. 8). For example, the seat bottom 78 includes a lower surface 80 that rests on at least a portion of saddle-type seat 26. The lower surface 80 of the seat bottom 78 may be formed to have a corresponding profile that interfaces with the saddle-type seat 26 as well as other parts of the ATV 10 (e.g., body panels, accessories, frame members, etc.) that may be in the proximity. The lower surface 80 may include surface features or profiles that enhance the interface between the seat bottom 78 and the ATV 10. For example, the lower surface 80 may be textured or treated (gels, rubbers, etc.) to increase traction between the seat bottom 78 and the saddle-type seat 26. The profile of the seat bottom 78 (e.g., on the lower surface 80) may be formed to interact with the corresponding structures of the ATV 10 such as flanges 82 that laterally flank the saddle-type seat 26 when coupled. The flanges 82 provide mechanical resistance against lateral movement (e.g., sliding) during use as well as help center the seat bottom 78 on the saddle-type seat 26. Other features may be included on the rider interface member 72 such as trenches 84 for coupling covers (e.g., vinyl covers) to the rider interface member 72. Various other features may be incorporated, including those known to those of skill in the art.

As previously mentioned, during use, the seat bottom 78 rests on and is supported by a portion of the saddle-type seat 26. By placing the seat bottom 78 in contact with the saddle-type seat 26, the amount of material (e.g., foam) beneath the passenger is increased (e.g., the foam of the saddle-type seat 26 and the foam of the seat bottom 78 of the rider interface member 72), making for a more comfortable ride. Furthermore, the amount of material used to construct the seat bottom 78 may be reduced, which allows the rider support assembly 38 to remain lighter and therefore more easily installed and removed from the ATV 10. Furthermore, the rider support assembly 38 does not require independent structural support for the seat bottom 78 (e.g., a typical seat bottom includes a hard-plastic shell supporting the seat bottom) as the seat bottom 78 is supported directly by the saddle-type seat 26. This further reduces the weight of the rider support assembly 38.

Referring now to the structural interface member 74, the seat back 76 is coupled thereto and supported by the frame 50 via the structural interface member 74. The structural interface member 74 is coupled to the seat back 76 via any number of methods (e.g., adhesives, fasteners, plastic welding, etc.). The structural interface member 74 includes a profile to support the seat back 76 such that the seat back 76 is ergonomic for the passenger. The structural interface member 74 may also include an extension portion 86 that wraps around an edge of the seat bottom 78. The extension portion 86 provides a position at which a vinyl cover (not shown) may be secured to the seat bottom 78.

Referring to FIGS. 7, 8, 10, and 11, the rider interface member 72 of the seating assembly 40 includes an aperture 88 formed through the seat back 76 and/or the seat bottom 78. The aperture provides access to the release mechanism 44 which is positioned proximate the aperture 88. By placing the aperture 88 through the rider interface member 72 for accessing the release mechanism 44, the user may release the rider support assembly 38 from the ATV 10 from a forward position. This allows the release mechanism 44 to be positioned away from accessories, racks, and the storage compartment 37, and limits interference with other components. It also provides easier access to the release mechanism 44, especially when accessories may cover or restrict access to the release mechanism 44 from the rear. Furthermore, the steps and running boards of the ATV 10 may be utilized when actuating the release mechanism 44 to provide the user better access to the rider support assembly 38 (e.g., from a height perspective). Because the seat back 76 and seat bottom 78 are an integral unit, the aperture 88 may be positioned through one or both of those members. As illustrated, the seat back 76 and seat bottom 78 of the rider interface member 72 are still integrally formed with two columns 90a, 90b flanking the aperture 88 and forming the transition between the seat back 76 and the seat bottom 78. The two columns 90a, 90b may form the living hinge between the seat back 76 and the seat bottom 78. The structural interface member 74 is formed to match the profile of the seat back 76 such that the structural interface member 74 does not interfere with access to the release mechanism 44 (e.g., via a recess or another aperture 92 matching the aperture 88 of the rider interface member 72).

Referring to FIG. 11, the structural interface member 74 may include a first member 94a and a second member 94b that are coupled around the frame 50 of the seat frame assembly 42. The first and second members 94a, 94b provide a secure coupling of the seating assembly 40 to the seat frame assembly 42 by surrounding portions of the frame 50. Each of the first and second members 94a, 94b include a channel 96 within which the frame 50 is positioned when the first and second members 94a, 94b are coupled together around the frame 50. The channel 96 has a profile similar to that of the frame 50, for example with two vertical portions and at least one horizontal portion connecting the vertical portions. Fasteners can be passed through the first and second members 94a, 94b as well as through the frame 50 to further secure the seating assembly 40 to the seat frame assembly 42.

FIG. 10 illustrates the seating assembly 40 and the seat frame assembly 42 when assembled. As is shown, the frame 50 may be exposed along portions of the structural interface member 74. The portions of the frame 50 that are exposed allow the frame 50 to also be used to attach accessories to the rider support assembly 38. For example, the structural interface member 74 includes portions at which the frame 50 is exposed such that the circumference of the frame 50 is not concealed by the structural interface member 74 along a longitudinal portion of the frame 50. Thus, the structural interface member 74 is spaced from the frame 50 such that a gap is formed between the outer surface of the structural interface member 74 and the frame 50 through which accessories may be passed, for example straps, clips, and other fasteners. This permits accessories to be directly coupled to the frame 50. Other features for coupling accessories to the structural interface member 74 directly may be provided, however, by having portions of the frame 50 exposed such that accessories may be coupled directly to the frame 50 allows the accessories to be securely supported and limits excess stress on the structural interface member 74 if accessories were to be coupled directly to the structural interface member 74.

The structural interface member 74 may also include features that facilitate securing of accessories to the frame 50. For example, the structural interface member 74 defines a recess 98 such that a portion of the frame 50 is circumferentially accessible at the recess 98. The recess 98 may have ramped surfaces 100 to maximize access to the gap between the outer surface of the structural interface member 74 and the frame 50.

Referring to FIG. 10, in some embodiments, the structural interface member 74 includes four locations which provide access to the frame 50 (e.g., exposed portion of the frame 50). The four locations each provide access to the frame 50 and limit movement of the accessories while the ATV 10 is moving. Thus, the exposed portions of the frame 50 formed by the recesses 98 of the structural interface member 74 allow users to use the frame 50 to mount accessories or other cargo. A cargo bag, backpack or other cargo can be attached to the rider support assembly 38 using the exposed portions of the frame 50 via hook and fastener straps, clamps, or other means of attachment. For example, hook and fastener straps can be fed around the exposed portions of the frame 50 in order to pull the cargo tight to the rider support assembly 38. It is also understood that other types of fasteners may be implemented to secure cargo to the exposed portions of the frame 50. It is understood that any number of exposed portions of the frame 50 may be provided and is not specifically limited to four. However, in one embodiment, there are at least two exposed portions that are vertically oriented and at least two exposed portions that are horizontally oriented. Although various integration features (not shown) may be included directly on the structural interface member 74 (e.g., clip receptors, slots, and so forth), the exposed portions of the frame 50 provide for universal integration and sturdy support of accessories and cargo.

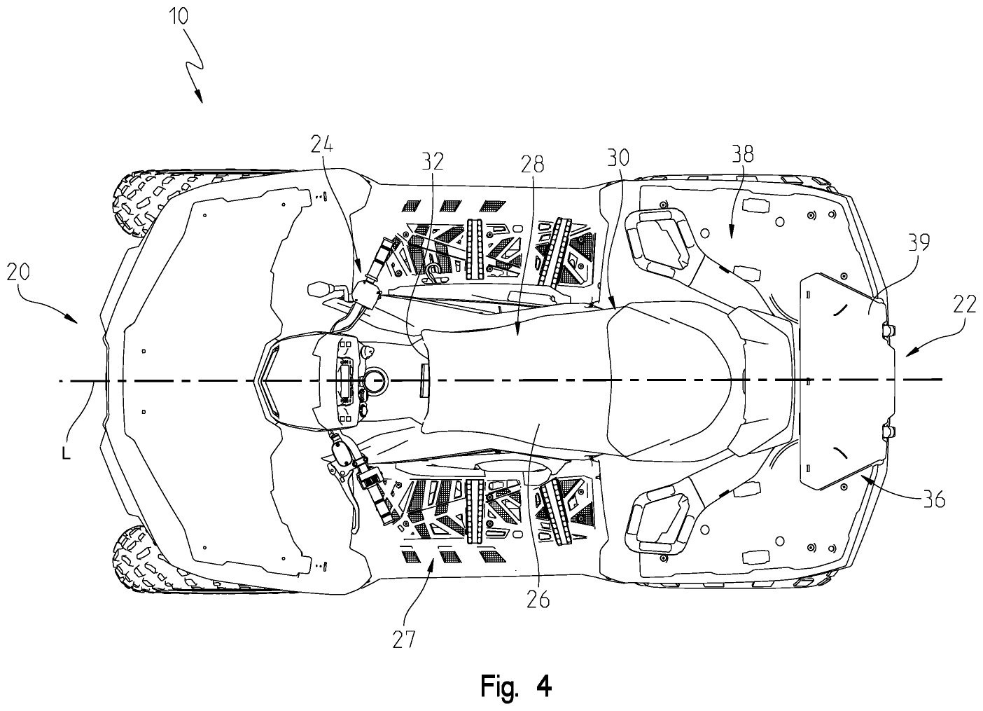

Referring now to FIGS. 10-13, the rider support assembly 38 may include arm supports 104 for supporting a user's arms during use. The arm supports 104 extend from the rider support assembly 38 and are positioned such that they do not occupy cargo space rearward of the rider support assembly 38. Because the arm supports 104 extend from the rider support assembly 38, the arm supports 104 are also installed and removed with the rider support assembly 38 as single, integral unit. The arm supports 104 are positioned to allow access to the seat back 76 and seat bottom 78, for example, the arm supports 104 extend longitudinally forward and laterally outward from the rider support assembly 38 such that the arm supports are non-parallel to each other. Various orientations are contemplated, including but not limited to between 15-60 degrees relative to a longitudinal axis L of the ATV 10 (FIG. 4). For example, the arm supports 104 may be about 20, 25, 30, 35, 40, or 45 degrees relative to the longitudinal axis L. By having the arm supports 104 angled outwardly, this configuration provides a more ergonomic position for the arms of a passenger and may more easily allow access the rider support assembly 38. This allows the passenger to access the seating position without incidentally contacting the arm supports 104 and/or allows the passenger to use the arm supports 104 as support during mounting and unmounting on and off the ATV 10. The arm supports 104 extend from the rider support assembly 38 at a vertical position above the seat bottom 78, for example from the rider support assembly 38 at the seat back 76.

Referring more specifically to the arm supports 104, the arm supports 104 include an body portion 106 and a grip portion 108. The body portion 106 is coupled to and extends from the rider support assembly 38. The body portion 106 is coupled to the frame 50 and therefore is firmly supported. The body portion 106 may be coupled to the frame 50 via a coupling plate 110 that extends along a length of the frame 50. The coupling plate 110 may be elongated to increase distribution of forces applied to the frame 50 via the arm supports 104 over a larger surface of the frame 50. It is understood that the body portion 106 may be coupled to the frame 50 either directly or indirectly and may be coupled via a variety of methods, including but not limited to fasteners, quick-release mechanisms, weldments, and so forth.

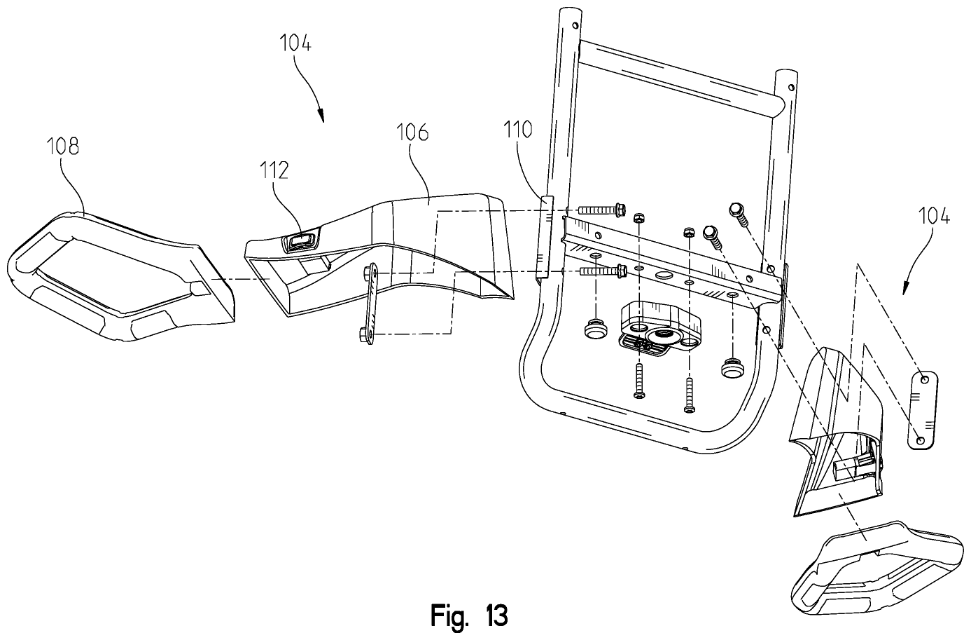

The grip portion 108 of the arm supports 104 may releasably couple to the body portion 106. This allows the grip portion 108 to be removed, installed, or replaced in the event of damage. Additionally, the removability of the grip portion 108 allows various designs and features to be implemented on the grip portion 108 (e.g., heated grips, various configurations such as circular or square, and so forth), or can be removed for more compact storage. Thus, the grip portion 108 may be modular and various types of grip portions 108 may be implemented on the rider support assembly 38. The grip portion 108, as mentioned, may include various features such as heated grips. The grip portion 108 may include embedded heaters (not shown) in the grip to allow a passenger to keep his or her hands warm when travelling in colder weather. The various features may be activated by a switch 112 that can be positioned either on the grip portion 108 or on the body portion 106 (as seen in FIG. 13). As previously discussed, the rider support assembly 38 may receive power from the ATV 10 via a wiring harness that is implemented separately from the release mechanism 44 or via the transfer over energy through the release mechanism 44. The switch 112 on the arm supports 104 may also be actuated to activate other accessories on the rider support assembly 38 such as heated seats.

With further reference to the grip portion 108, the grip portion 108 may be adjusted to various positions for providing a more comfortable experience for the rider. This can be accomplished at the interface of the grip portion 108 and the body portion 106. The various positions may also allow the passenger to adjust the grip portion to varying height levels or lateral positions for riding conditions. As illustrated, the profile of the grip portion 108 with which the passenger interfaces may be a non-round tubing (e.g., tear drop shaped tubing). Furthermore, the tubing shape may be formed in a diamond or D-shape making a closed ring which the passenger can grip during riding. It is understood that any variety of configurations of the grip portion 108 may be implemented to provide a comfortable and safe experience for the passenger.

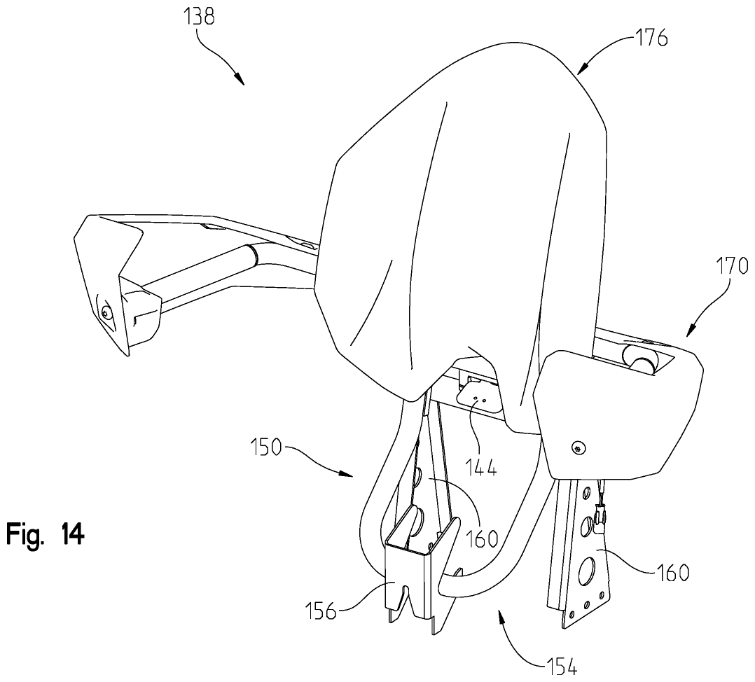

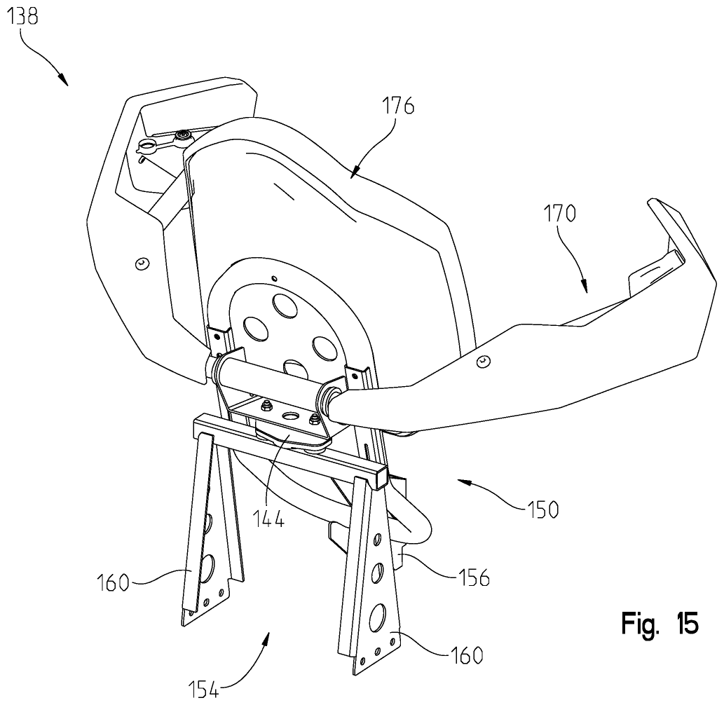

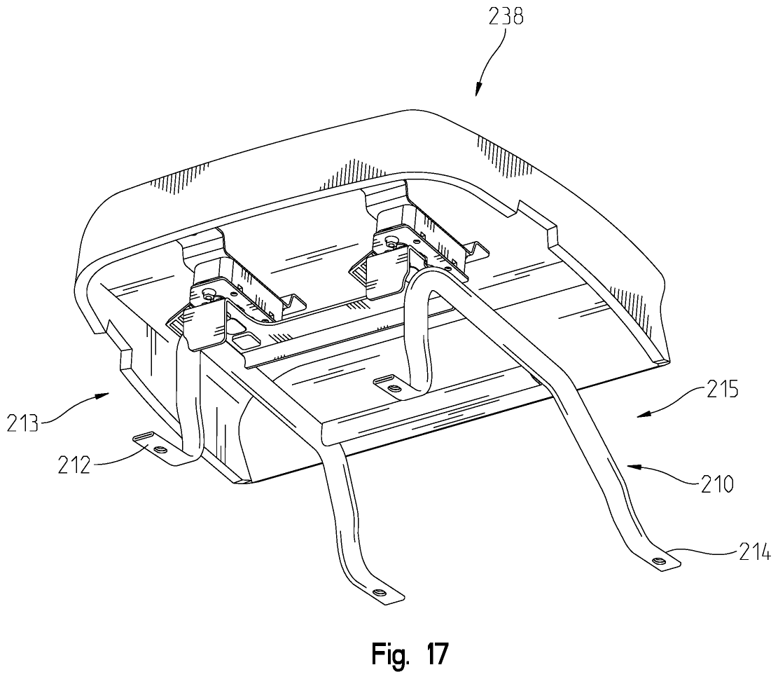

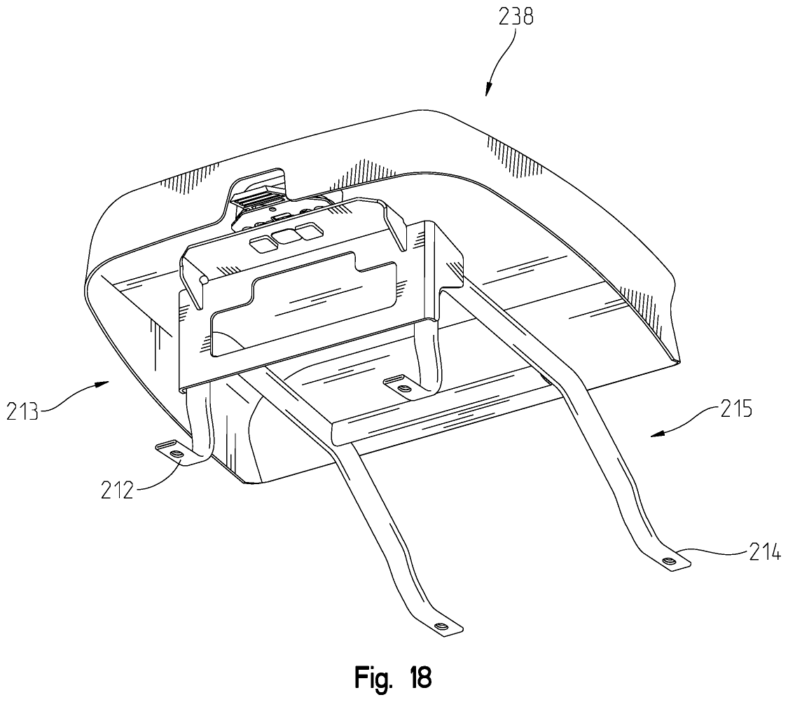

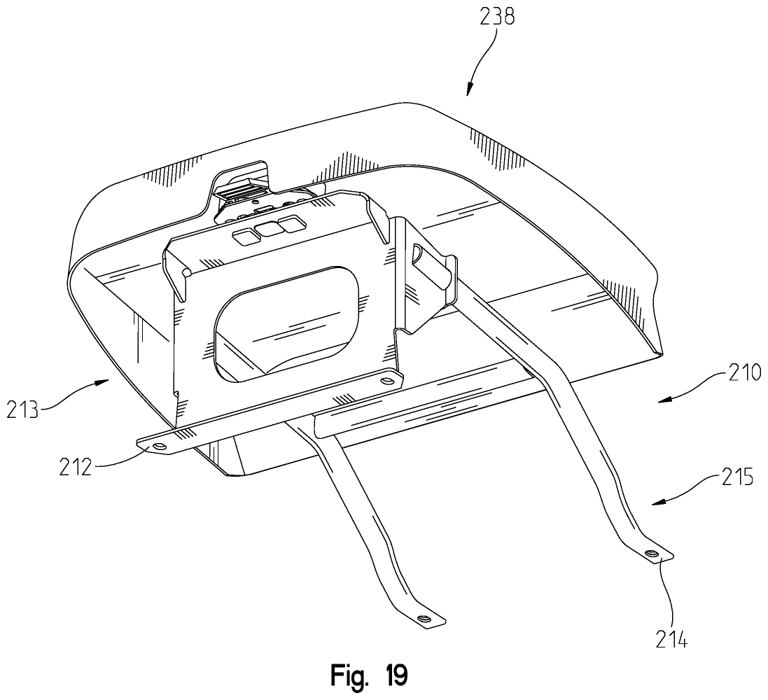

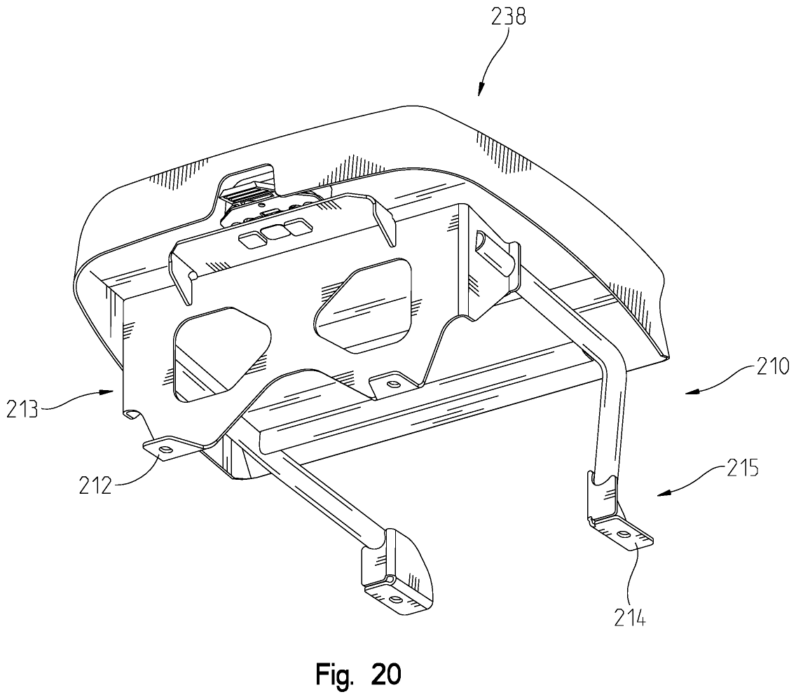

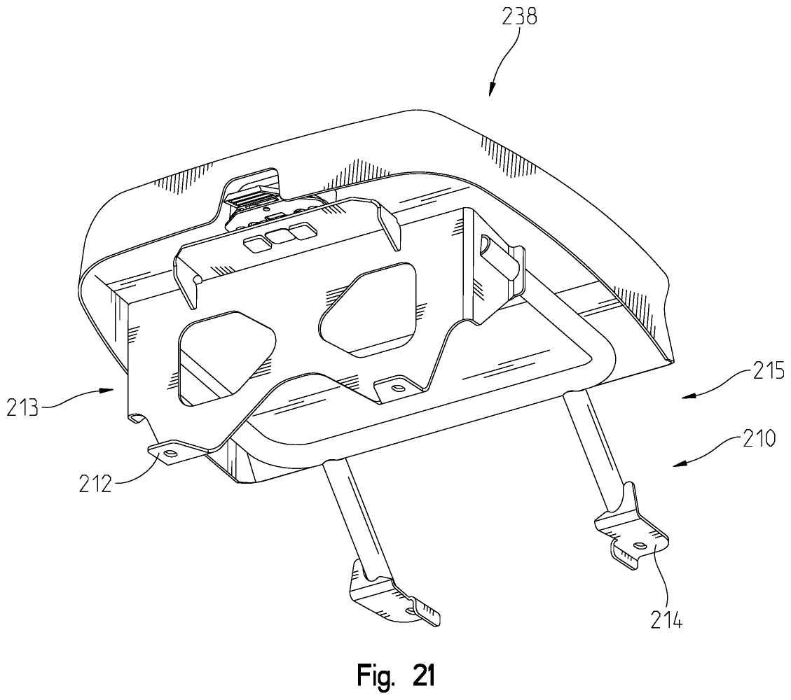

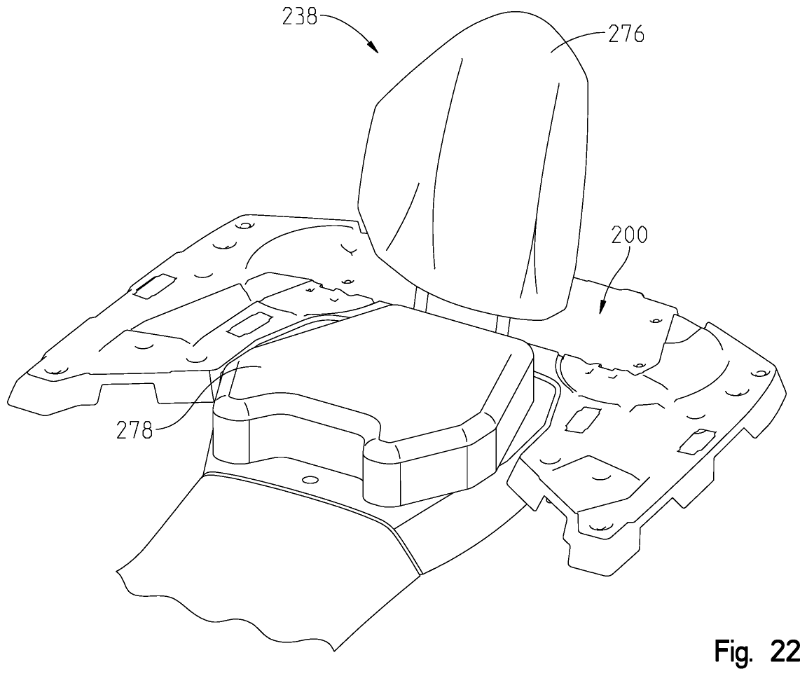

Referring now to FIGS. 14-23, various other embodiments of a rider support assembly may be implemented. For example, FIGS. 14 and 15 illustrate a rider support assembly 138 that includes a frame 150 to which a seat back 176 is coupled. The frame 150 includes a vehicle interface portion 154. The vehicle interface portion 154 is releasably retained by a portion of the ATV 10 (e.g., a bracket 156 that is coupled to the ATV 10). The frame 150 may include a curved portion to allow the frame 150 to be positioned on the ATV 10 (e.g., can be slid behind and under the saddle-type seat 26). The rider support assembly 138 also includes a release mechanism 144 similar to that previously discussed. The seat back 176 is formed such that the release mechanism 144 is accessible from a front of the rider support assembly 138. The rider support assembly 138 also includes support members 160 that extend from the frame 150 (either integrally formed with or coupled to and extending from the frame 150). The support members 160 extend from opposite lateral ends of the frame 150 to provide further structural support to the rider support assembly 138. For example, the support members 160 may contact portions of the ATV 10 to provide further structural contacts with the ATV 10 in addition to the release mechanism 144 and the vehicle interface portion 154. The support members 160 may also be releasably coupled to the ATV 10 in some embodiments. The rider support assembly 138 also includes arm supports 170. The arm supports 170 extend from the frame 150 at a position vertically between a top and a bottom of the seat back 176. The embodiment illustrated in FIGS. 14-15 does not include a seat bottom, the passenger being able to be positioned on a rear portion of the saddle-type seat 26.

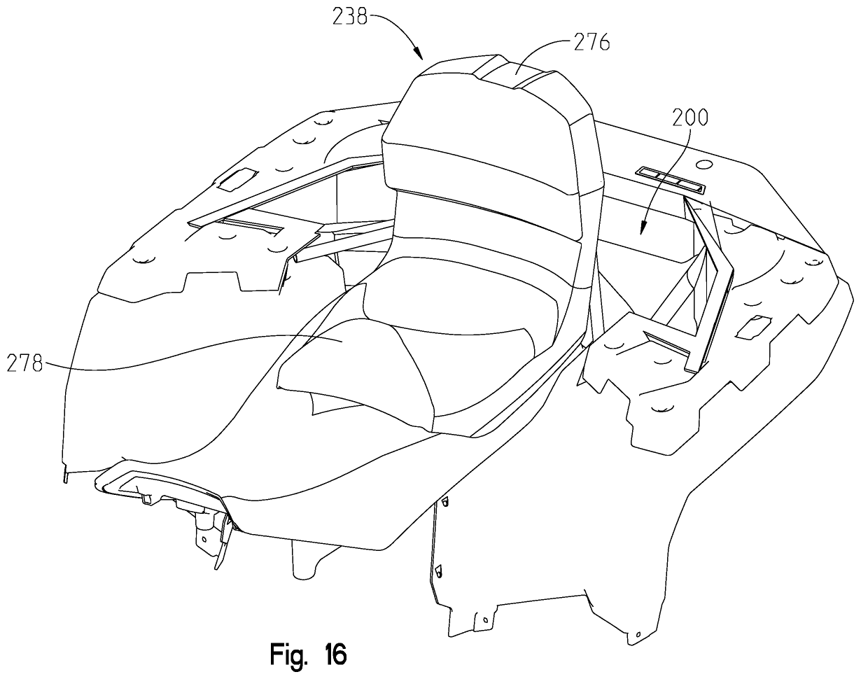

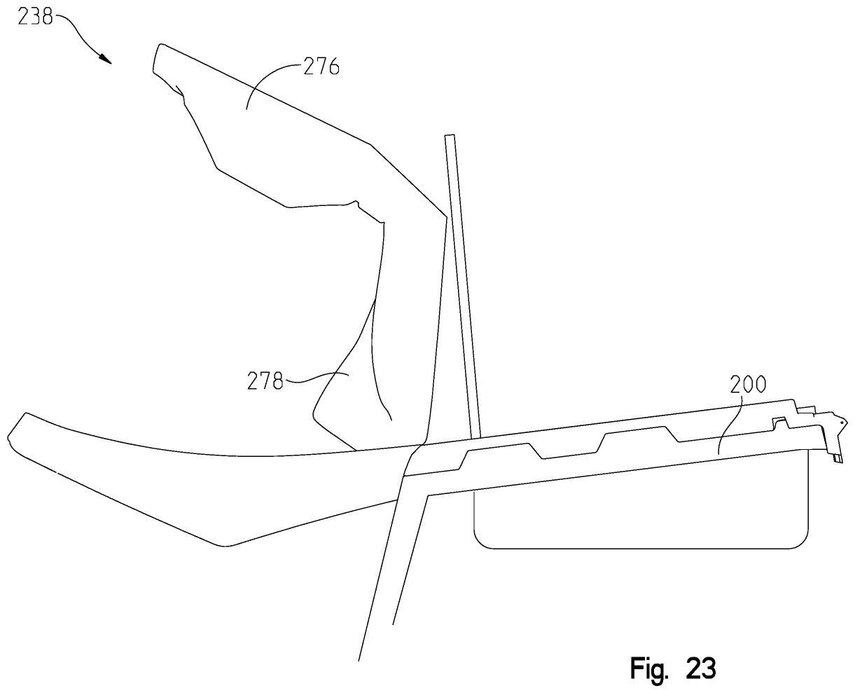

Referring to FIGS. 16-23, in various embodiments, a rider support assembly 238 may be positioned vertically above and concealing a storage compartment 200. The rider support assembly 238 includes a bracket 210 which interfaces with the ATV 10. For example, the bracket 210 supports a seat back 276 and a seat bottom 278 (and in some embodiments, only a seat bottom 278). Various embodiments of seat backs and seat bottoms may be implemented, and those illustrated are an example of types that might be implemented. By having the bracket 210 supporting both the seat back 276 and seat bottom 278, the seat back 276 and the seat bottom 278 may be implemented in a fixed configuration (e.g., the seat back 276 does not pivot relative to the seat bottom 278). Instead, the bracket 210 is operable to couple to and be released from the ATV 10. In some embodiments, the bracket 210 includes tabs 212 at a front portion 213 and coupling members 214 at a rear portion 215. The coupling members 214 may be secured to the ATV 10 and the tabs 212 may be retained by the ATV 10. The tabs 212 are first inserted into a corresponding feature on the ATV 10 and then the coupling members 214 are engaged with a corresponding feature on the ATV 10 which releasably locks to rider support assembly 238 in place on the ATV 10. The coupling member 214 may be released and the rider support assembly 238 may be pivoted upward to allow access into the storage compartment (see FIG. 23). Various configuration of brackets may be implemented as illustrated in FIGS. 16-20.

It is understood that the disclosed embodiments may be implemented as a retrofittable kit or assembly for ATV's 10 and may be configured to be installed on an existing ATV 10 or the disclosed embodiments may be implemented during production of the ATV 10 by the original equipment manufacturer (“OEM”).

The above detailed description of the present disclosure and the examples described therein have been presented for the purposes of illustration and description only and not by limitation. It is therefore contemplated that the present disclosure covers any and all modifications, variations or equivalents that fall within the scope of the basic underlying principles disclosed above and claimed herein. Moreover, the inventive concepts hereby addressed have been described above both generically and with regard to specific examples. It will be apparent to those skilled in the art that various modifications and variations can be made in the examples without departing from the scope of the disclosure. Likewise, the various components discussed in the examples are combinable. Thus, it is intended that the examples be viewed collectively, as a whole, as also intimating various modifications and variations of those specific examples.

1. A vehicle comprising:
a vehicle frame;
a saddle-type seat mounted to the frame and having a forward portion and a rearward portion;
a cargo area defining a storage compartment positioned at least partially rearward of the saddle-type seat; and
a rider support assembly positioned rearward of the forward portion of the saddle-type seat and vertically above at least a portion of the saddle-type seat and the storage compartment.

2. The vehicle of claim 1, wherein the rider support assembly includes a seat frame assembly and a seating assembly supported by the seat frame assembly.

3. The vehicle of claim 2, wherein the seating assembly includes a support member coupled to the seat frame assembly and an interface member coupled to the support member.

4. The vehicle of claim 3, wherein the interface member includes a seat back and a seat bottom integrally formed with each other.

5. The vehicle of claim 4, wherein the seat bottom includes a top surface operable to support a rider and a bottom surface operable to interface with the saddle-type seat.

6. The vehicle of claim 5, wherein the interface member is formed of a compressible material.

7. The vehicle of claim 3, wherein the seat bottom is pivotable relative to the seat back.

8. The vehicle of claim 2, wherein at least a portion of the seat frame assembly is exposed through the seating assembly.

9. The vehicle of claim 8, wherein the seating assembly defines a channel within which the seat frame assembly is positioned, and wherein the seating assembly defines a recess such that a portion of the seat frame assembly is circumferentially accessible at the recess in the seating assembly.

10. The vehicle of claim 9, wherein the recess extends such that the seating assembly is spaced from the seat frame assembly at the recess.

11. The vehicle of claim 2, wherein the seat frame assembly includes a release mechanism operable to be actuated to release the rider support assembly from the vehicle.

12. The vehicle of claim 11, further comprising a corresponding coupling member operably engaged to the release mechanism of the seat frame assembly to couple the seat frame assembly to the vehicle.

13. The vehicle of claim 12, wherein the seat frame assembly includes an aperture defined therethrough, and wherein the release mechanism is positioned proximate the aperture.

14. The vehicle of claim 13, wherein the corresponding coupling member is electrified such that when the release mechanism and the corresponding coupling member are in contact, a circuit of the seat frame assembly is completed.

15. The vehicle of claim 2, wherein the vehicle includes retainer is positioned on the cargo area for anchoring the seat assembly to the vehicle.

16. The vehicle of claim 15, wherein the cargo area includes location members extending therefrom, the cargo areas operable to align the anchoring portion of the seat frame assembly with the retainer during installation of the rider support assembly.

17. The vehicle of claim 2, wherein the rider support assembly includes arm supports extending therefrom.

18. The vehicle of claim 17, wherein the arm supports include a body portion and a grip portion removably coupled to the body portion.

19. The vehicle of claim 17, wherein the arm supports extend from the rider support assembly at a position vertically above a seat bottom.

20. A rider support assembly, comprising:
a seat frame assembly coupling portion operable to be coupled to a seat of a vehicle and a vertically extending member extending substantially vertically from the coupling portion; and
a seating assembly including:
a structural interface member coupled to the vertically extending member of the seat frame assembly; and
a rider interface member coupled to the support member, the rider interface member including a seat back and a seat bottom, the seat back being supported by the structural interface member.

21. The vehicle of claim 20, wherein the seating assembly includes a support member coupled to the seat frame assembly and an interface member coupled to the support member.

22. The vehicle of claim 21, wherein the interface member includes a seat back and a seat bottom integrally formed with each other.
